(19) United States
(12) Patent Application Publication
(10) Pub. No.: US 2010/0056245 A1
(43) Pub. Date: Mar. 4, 2010

(54) GAMING SYSTEM, GAMING MACHINE, AND PLAY METHOD THEREOF

(75) Inventor: Yukinori INAMURA, Koto-ku (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Aruze Corp., Koto-ku (JP)

(21) Appl. No.: 12/510,477

(22) Filed: Jul. 28, 2009

Related U.S. Application Data
(60) Provisional application No. 61/092,265, filed on Aug. 27, 2008.

(51) Int. Cl. A63F 9/24; A63F 13/00

(52) U.S. Cl. 463/17; 463/30; 463/42

(57) ABSTRACT

Selections of an arbitrary number of numbers are accepted from numbers 1 to 80 and then twenty elements are drawn from eighty elements each numbered with a number 1 through 80. Then, an award is provided according to the number of matching numbers between the numbers on the drawn elements and the selected numbers. In addition, in a case where a predetermined condition has been bet such as consecutively playing games of the same type, no award during a predetermined consecutive games or the like, an elimination processing is executed to eliminate elements, for example, ten elements are eliminated. Since a total number of elements is changed to seventy, a matching probability between the numbers on the drawn elements and the selected numbers is made higher, so that awarding probability to a player is made higher.

### CROSS-REFERENCE TO RELATED APPLICATION

This application is based upon and claims the benefit of U.S. Provisional Patent Application Ser. No. 61/092,265, filed on Aug. 27, 2008; the entire contents of which are incorporated herein by reference for all purposes.

### BACKGROUND OF THE INVENTION

1. Field of the Invention

The present invention relates to a gaming machine, a gaming system and a playing method of a gaming machine for playing a game using game media such as coins and bills.

2. Description of Related Art

Known is a conventional example of a gaming machine playing Keno games as disclosed in U.S. Pat. No. 7,258,608. In this U.S. Pat. No. 7,258,608, a player selects a predetermined number of numbers (e.g. six numbers) from eighty elements each numbered with a number 1 through 80. Then, twenty elements are drawn from the eighty elements each numbered with a number 1 through 80 to compare numbers of the drawn elements and numbers derived from these numbers with numbers selected by the player and an award will be provided according to the number of matching numbers.

In such a conventional gaming machine, it is only brought that matching probability between the selected numbers selected by the player and the derived numbers. It has been desired that a gaming machine with a new entertainment feature is brought.

### SUMMARY OF THE INVENTION

A first aspect of the present invention provides a playing method of a gaming machine that includes: determining whether or not a predetermined condition relating to a game execution has been met; executing, upon the predetermined condition being met, an elimination processing for eliminating a predetermined number of numbers from a total number of numbers; setting the total number of numbers to an overall total number P in a case where the elimination processing has not been executed or setting a resulting number after the elimination processing to an overall total number P in a case where the elimination processing has been executed; storing n (1≦n<P) number of numbers arbitrarily selected by a player from the overall total number P number of numbers; drawing m (1≦m<P) number of numbers at random from the overall total number P number of numbers; and determining an award according to the number of player-selected numbers included in the m number of drawn numbers.

A second aspect of the present invention provides a gaming machine that includes: a display for displaying images relating to a game thereon; and a controller being programmed to execute following (a) to (f): (a) an elimination processing for determining whether or not a predetermined condition relating to a game execution has been met and eliminating, upon the predetermined condition being met, a predetermined number of numbers from a total number of numbers; (b) a processing for setting the total number of numbers to an overall total number P in a case where the elimination processing has not been executed or setting a resulting number after the elimination processing to an overall total number P in a case where the elimination processing has been executed; (c) a processing for accepting selections of n (1≦n<P) number of arbitrary numbers from the overall total number P number of numbers; (d) a processing for drawing m (1≦m<P) number of numbers at random from the overall total number P number of numbers; (e) a processing for acquiring the number of matching numbers through a comparison between the m number of drawn numbers and the n number of selected numbers; and (f) a processing for providing an award according to the number of matching numbers.

A third aspect of the present invention provides a gaming system that includes: a plurality of gaming machines and a host server connected with each of the plurality of gaming machines via a network. The host server includes: a main display; and a server controller being programmed to execute following (a) to (c): (a) an elimination processing for determining whether or not a predetermined condition has been met and eliminating, upon the predetermined condition being met, a predetermined number of numbers from a total number of numbers; (b) a processing for setting the total number of numbers to an overall total number P in a case where the elimination processing has not been executed or setting a resulting number after the elimination processing to an overall total number P in a case where the elimination processing has been executed; and (c) a processing for drawing m (1≦m<P) number of numbers at random from the overall total number P number of numbers. Each of the plurality of gaming machines includes a terminal controller being programmed to execute following (A) to (C) : (A) a processing for accepting selections of n (1≦n<P) number of arbitrary numbers from the overall total number P number of numbers; (B) a processing for acquiring the number of matching numbers through a comparison between the m number of drawn numbers and the n number of selected numbers; and (C) a processing for providing an award according to the number of matching numbers.

### BRIEF DESCRIPTION OF THE DRAWINGS

FIG. 1 is an appearance view of a gaming machine according to first to fourth embodiments of the present invention;

FIG. 2 is a block diagram showing an electronic configuration of the gaming machine according to the first to third embodiments of the present invention;

FIG. 3 is an appearance view of a gaming system according to the fourth embodiment of the present invention;

FIG. 4 is a block diagram showing an electronic configuration of the gaming machine in the fourth embodiment of the present invention;

FIG. 5 is a block diagram showing an electronic configuration of a host server in the fourth embodiment of the present invention;

FIG. 6 is a flow-chart showing operations of the gaming machine according to the first embodiment of the present invention;

FIG. 7 is a flow-chart showing game selection processing in the first embodiment of the present invention;

FIG. 8 is a flow-chart showing setting processing of the number of consecutive games in the first embodiment of the present invention;

FIG. 9 is a flow-chart showing element elimination processing in the first embodiment of the present invention;

FIG. 10 is a flow-chart showing operations of the gaming machine according to the second embodiment of the present invention;

FIG. 11 is a flow-chart showing element elimination processing in the second embodiment of the present invention;

FIG. 12 is a flow-chart showing operations of the gaming machine according to the third embodiment of the present invention;

FIG. 13 is a flow-chart showing element elimination processing in the third embodiment of the present invention;

FIG. 14 is a flow-chart showing operations of the host server in the fourth embodiment of the present invention;

FIG. 15 is a flow-chart showing element elimination processing in the fourth embodiment of the present invention;

FIG. 16 is a flow-chart showing operations of the gaming machine in the fourth embodiment of the present invention;

FIG. 17 is a diagram showing a random number table used in the first to fourth embodiments of the present invention;

FIG. 18 is a diagram showing a screen display of a game selection in the gaming machine according to the present invention;

FIG. 19 is a diagram showing a screen display at a “Bet” game execution in the gaming machine according to the present invention;

FIG. 20 is a diagram showing a screen display upon generating a right to eliminate some numbers in the gaming machine according to the present invention;

FIG. 21 is a diagram showing a screen display upon eliminating some numbers in the gaming machine according to the present invention;

FIG. 22 is a diagram showing a screen display at the “Bet” game execution after eliminating some numbers in the gaming machine according to the present invention;

FIG. 23 is a diagram showing a screen display at a “High Roller” game execution in the gaming machine according to the present invention;

FIG. 24 is a diagram showing a screen display at a “Top or Bottom” game execution in the gaming machine according to the present invention;

FIG. 25 is a diagram showing a screen display at a “Catch All” game execution in the gaming machine according to the present invention;

FIG. 26 is a diagram showing a screen display of a consecutive games selection in the gaming machine according to the present invention;

FIG. 27 is a diagram showing a payout table for the “Bet” game according to the present invention;

FIG. 28 is a diagram showing a payout table for the “Catch All” game according to the present invention; and

FIG. 29 is a diagram showing a payout table for the “Top or Bottom” game according to the present invention.

### DETAILED DESCRIPTION OF THE EMBODIMENT

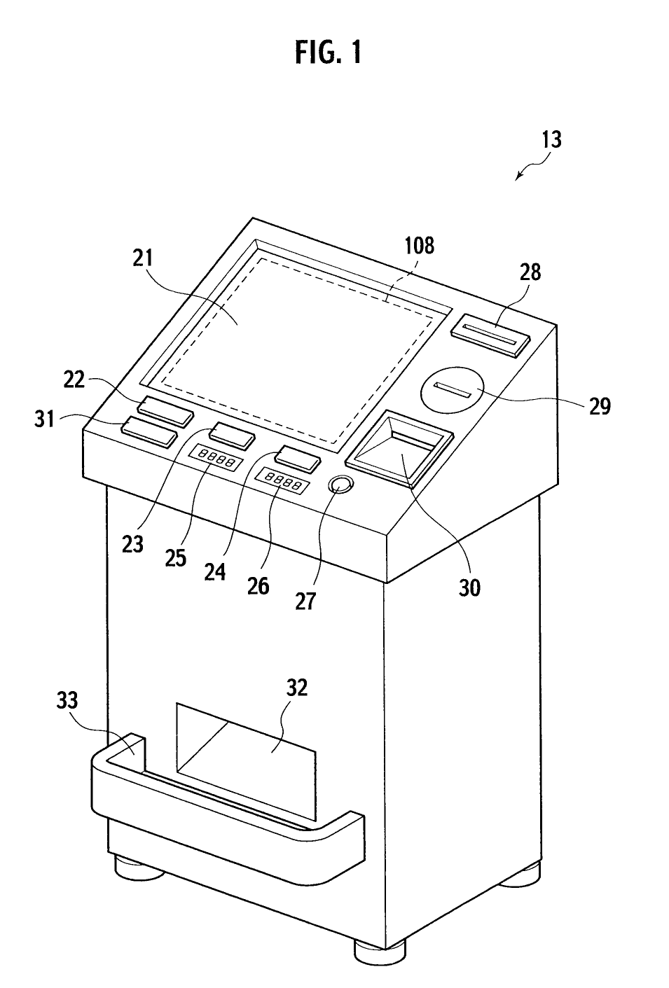

FIG. 1 is an appearance view of a gaming machine 13 according to the present invention. As shown in FIG. 1, the gaming machine 13 includes a display 21 for displaying various images, a bet button 23 for placing a one-credit bet, a max-bet button 24 for placing a bet with a maximum credit amount, a repeat-bet button 22 for placing a bet with the same credit amount as in a last play, a side-bet button 31 for placing a side bet to execute an after-mentioned element eliminating processing, a credit amount indicator 25 for displaying a current credit amount, a bet amount indicator 26 for displaying a bet amount and a payout button 27 for paying out coins.

Further, included are a medal insertion slot 29 into which a coin(s) is inserted, a ticket printer 28 for printing out data on plays such as a payout amount, a bill insertion slot 30 into which a bill(s) is inserted. In addition, a payout opening 32 for paying-out coins is provided on a lower part of the gaming machine 13 and further an under tray 33 for accumulating paid-out coins is provided beneath the payout opening 32.

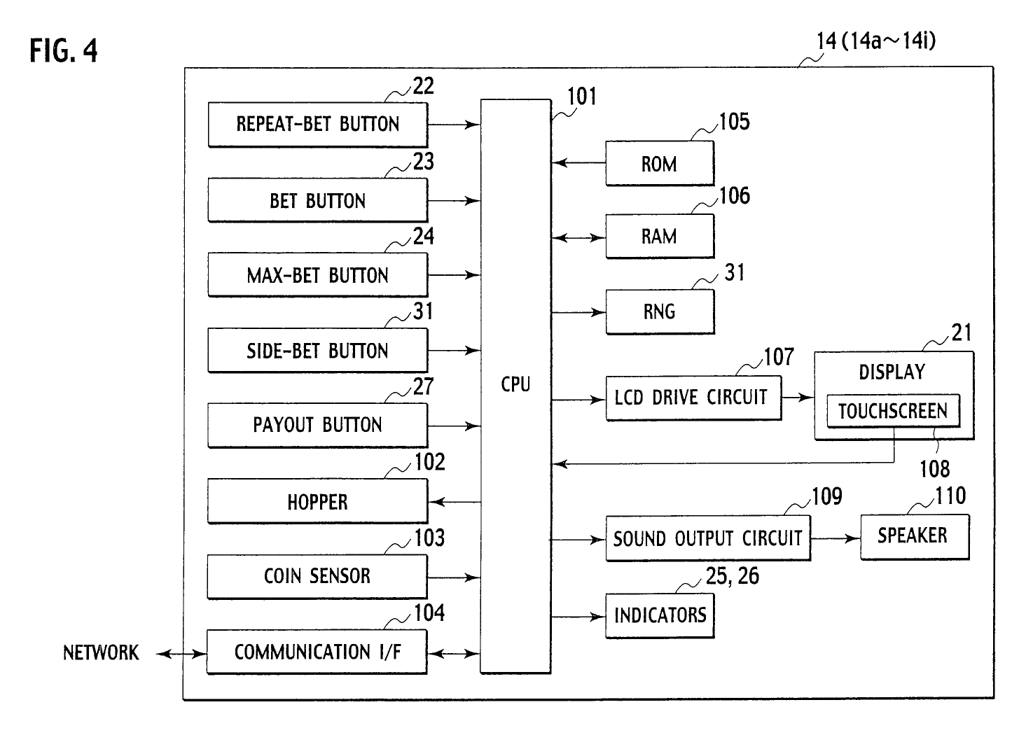

FIG. 4 is a block diagram showing an internal configuration of the gaming machine 13 according to the present embodiment. As shown in FIG. 4, the gaming machine 13 includes a CPU 101, a ROM 105 and a RAM 106. The ROM 105 is composed of semiconductor memories or the like, for example, and stores programs for achieving basic functionality of the gaming machine 13, various other programs necessary to control the gaming machine 13, data tables and so on. In addition, the RAM 106 is a memory for temporarily storing a variety of data calculated by the CPU 101, a current credit amount owned by a player (stored in the gaming machine 13), player's betting status and so on.

In addition, the bet button 23, the max-bet button 24, the repeat-bet button 22, the side-bet button 31 and the payout button 27 are connected to the CPU 101 as mentioned above. Furthermore, both of the credit amount indicator 25 and the bet amount indicator 26 are connected to the CPU 101. In addition, a hopper 102 and a coin sensor 103 are connected to the CPU 101.

The CPU 101 controls executions of various corresponding operations based on operation signals had been output due to pressing down the buttons 22, 23, 24, 27 and 31. Specifically, the CPU 101 executes various processings in response to player's input operations based on input signals supplied from the buttons 22, 23, 24, 27 and 31 and data/programs stored in the ROM 105 and the RAM 106.

The coin sensor 103 detects coins inserted into the coin insertion slot 29 to count the number of inserted coins and outputs counting result data to the CPU 101. The CPU 101 increases the credit amount owned by a player and stored in the RAM 106 based on the counting result data.

The hopper 102 payouts a predetermined number of coins from the payout opening 32 (see FIG. 1) based on a command signal output from the CPU 101.

In addition, an LCD drive circuit 107 and a sound output circuit 109 are connected to the CPU 101. The LCD drive circuit 107 controls screen images displayed on the display 21. The LCD drive circuit 107 includes a program ROM, an image ROM, an image control CPU, a work RAM, a VDP (video display processor) and a video RAM.

The program ROM stores image control programs relating to screen-displays on the display 21 and various selection tables. The image ROM stores, for example, dot data for forming images to be displayed on the display 21. The image control CPU determines, images to be displayed on the display 21 among the dot data preliminarily stored in the image ROM according to the image control programs preliminarily stored in the program ROM based on parameters had been set by the CPU 101.

The work RAM is configured as a temporary memory device during execution of the image control programs by the image control CPU. The VDP forms screen images according to display contents determined by the image control CPU and outputs them to the display 21. Note that the video RAM is also configured as a temporary memory device during formation of the screen images by the VDP.

In addition, a touchscreen 108 for accepting player's touch operations and outputting input signals to the CPU 101 is provided on the display 21. The touchscreen 108 is used for operations such as selection of elements to be eliminated at execution of Keno game as explained later. Here the “elements” are balls each numbered with a number 1 through 80, for example.

The sound output circuit 109 controls producing various sound effects and is connected with a speaker 110.

Next, a Keno game will be explained executed at the gaming machine 13 according to the present embodiment. In the Keno game, four types of games, “Bet”, “Catch All”, “High Roller” and “Top or Bottom” are preset and they are explained hereinafter.

### (i) “Bet”

In this game, player's selections of arbitrary one to fifteen of numbers are accepted from eighty elements each numbered with a number 1 through 80. Next, a process to draw one element at random from the eighty elements is executed and then this process is repeated twenty times to draw twenty numbers in total. Subsequently, the one to fifteen of numbers selected by the player and the drawn twenty numbers are compared and then a payout will be awarded according to the number of matching numbers.

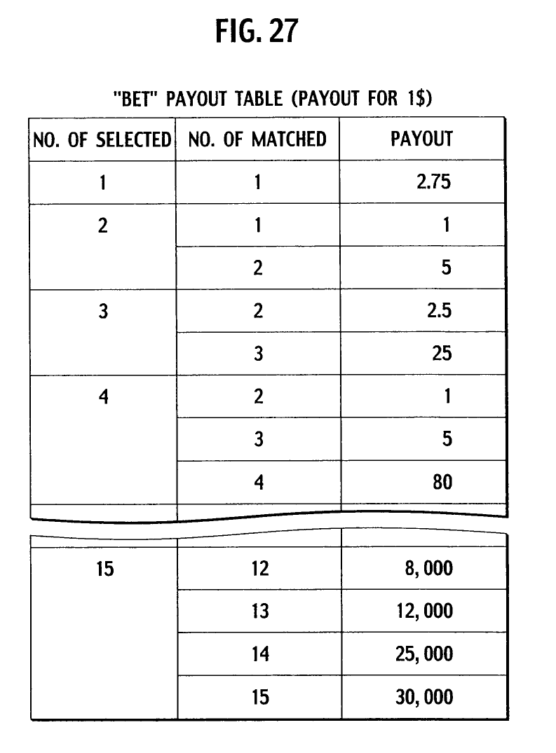

FIG. 27 is an explanatory diagram showing a payout table in a “Bet” game. A 2.75-dollar payout will be awarded for a 1-dollar bet in a case where the number of selected numbers is “one” and the number of matching numbers on the drawn elements is “one”. An 8,000-dollar payout will be awarded for a 1-dollar bet in a case where the number of selected numbers is “fifteen” and the number of matching numbers on the drawn elements is “twelve”.

### (2) “Catch All”

In this game, player's selections of arbitrary two to seven of numbers are accepted from eighty elements each numbered with a number 1 through 80. Next, a process to draw one element at random from the eighty elements is executed and then this process is repeated twenty times to draw twenty numbers in total. Subsequently, a payout will be awarded in a case where all the two to seven of numbers selected by the player are included in the drawn twenty numbers.

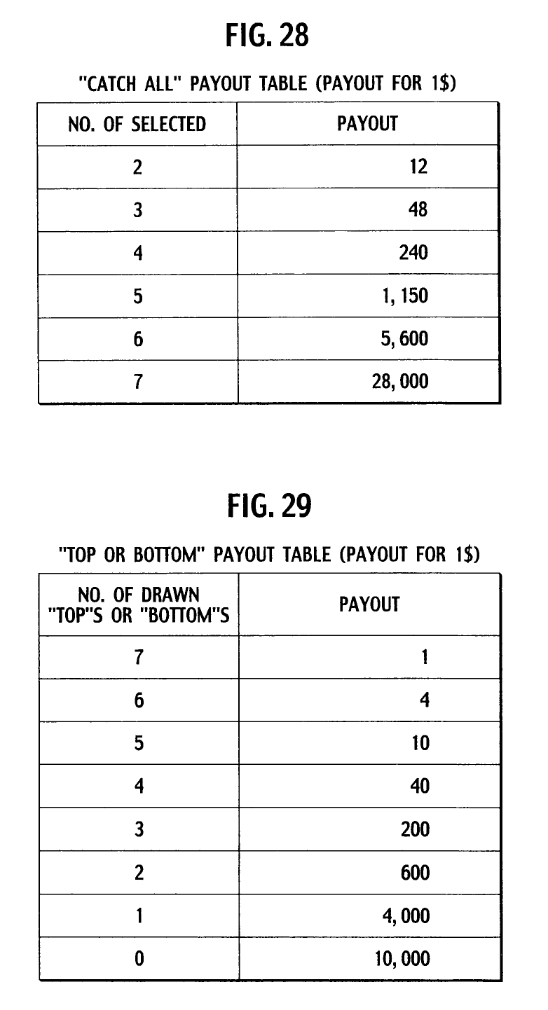

FIG. 28 is an explanatory diagram showing a payout table in a “Catch All” game. A 12-dollar payout will be awarded for a 1-dollar bet in a case where the number of selected numbers is “two” and all the elements of the two numbers are drawn. A 28,000-dollar payout will be awarded for a 1-dollar bet in a case where the number of selected numbers is “seven” and all the elements of the seven numbers are drawn.

### (3) “High Roller”

This game takes the same method as the above-mentioned “Bet” game. However, its payout table is differentiated. In a “High Roller” game, a payout amount is set larger than in a “Bet” game as the number of matching elements increases.

### (4) “Top or Bottom”

In this game, forty elements each numbered with a number 1 through 40 are set as tops and forty elements each numbered with a number 41 through 80 are set as tops among the eighty elements. And a player selects a “Top or Bottom” game. Next, a process to draw one element at random from the eighty elements is executed and then this process is repeated twenty times to draw twenty numbers in total. Subsequently, a payout will be awarded according to the number of top numbers or bottom numbers.

FIG. 29 is an explanatory diagram showing a payout table in a “Top or Bottom” game. A 1-dollar payout will be awarded for a 1-dollar bet in a case where the number of elements each numbered with any of a top or a bottom is “seven”. A 1,000-dollar payout will be awarded in a case where the number of elements each numbered with any of a top or a bottom is zero, in other words, where the twenty drawn numbers are all tops or all bottoms. Specifically, numbers on the drawn elements presents the larger disproportionate toward top or bottom, the more payout will be awarded.

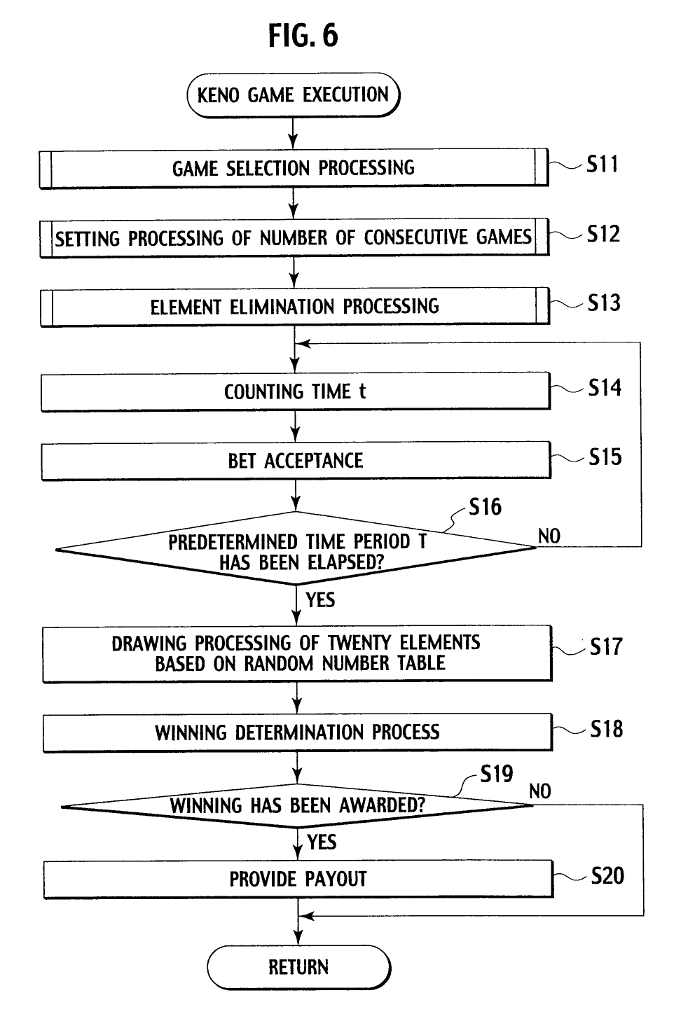

Next, operations of a gaming machine in a first embodiment according to the present invention will be explained with reference to flow-charts shown in FIGS. 6 to 9.

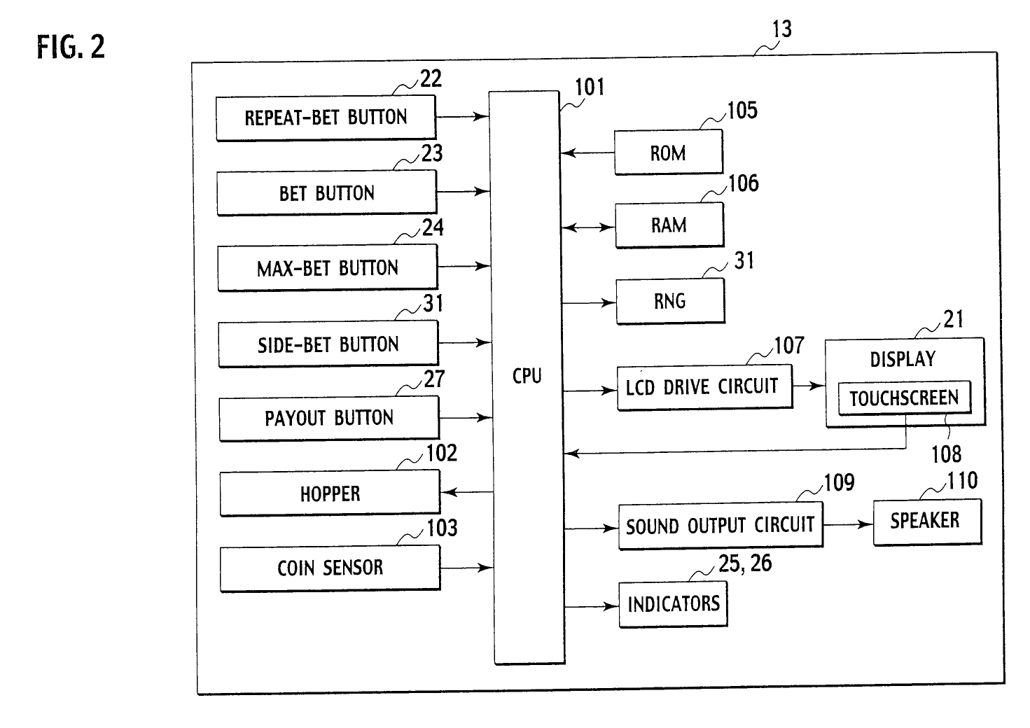

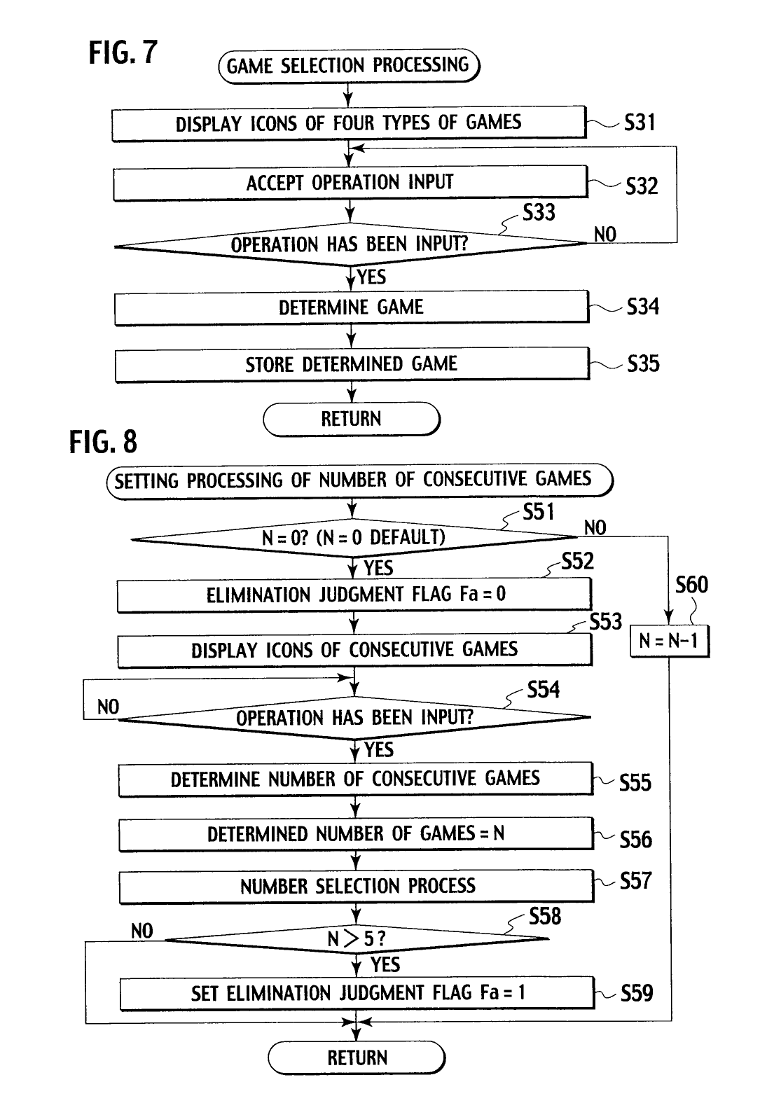

FIG. 6 is a flow-chart showing execution processes of a Keno game according to the first embodiment. Upon starting a Keno game, in step S11, the CPU 101 (see FIG. 2) executes a game selection processing. In the game selection processing, any one of the above-mentioned four types of games “Bet”, “Catch All”, “High Roller” and “Top or Bottom is elected by a player. Its detail will be explained later with reference to a flow-chart shown in FIG. 7.

In step S12, the CPU 101 executes a setting processing of the number of consecutive games. In this processing, accepted is setting of the number of consecutive games of an identical type of games. Through the consecutive games, an identical set of selected numbers is used successively. For example, the above-mentioned “Bet” game with a set of selected six numbers “2, 4, 7, 11 and 15” is executed ten times successively. Its detail will be explained later with reference to a flow-chart shown in FIG. 8.

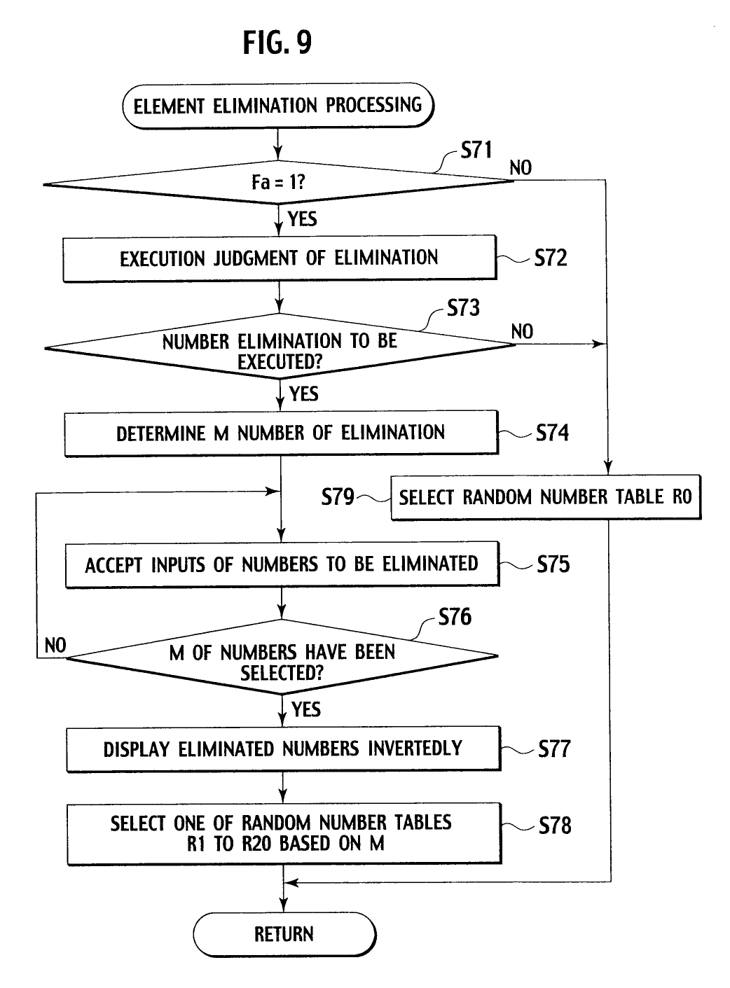

In step S13, the CPU 101 executes an element elimination processing. In this processing, the number of total elements is decreased by eliminating a predetermined number of elements from eighty elements in a case where an after-mentioned condition has been met. Its detail will be explained later with reference to a flow-chart shown in FIG. 9.

In step S14, the CPU 101 puts a timer implemented in the RAM 106 into operation to count an elapsed time t from a Keno game start.

In step S15, the CPU 101 accepts a bet. In this process, a credit amount is accumulated according to an inserted amount of coins or bills after accepting a coin insertion into the medal insertion slot 29 and a bill insertion into the bill insertion slot 30 by a player to display the credit amount on the credit amount indicator 25. Further, operations onto the bet button 23, the max-bet button 24 and the repeat-bet button 22 are accepted and a bet of credits according to the operations onto the buttons is placed. The bet credits is displayed on the bet amount indicator 26 and the credit amount had been decreased by the bet credit is displayed on the credit amount indicator 25.

In step S16, the CPU 101 determines whether or not the counted time t by the timer has reached a predetermined time T. If it has reached to the predetermined time T, the bet acceptance is terminated.

In step S17, the CPU 101 repeats a process twenty times in which one element is drawn at random from the eighty elements (the elements after the elimination in a case where some elements has been eliminated in the processing of step S13; e.g. seventy elements) to draw twenty elements in total.

In step S18, the CPU 101 executes a winning determination processing. In this processing, a winning determination is made according to each type of games. For example, in a case where a “Bet” game has been selected, the winning determination processing is executed with reference to the winning table shown in FIG. 27 by comparing the one to fifteen numbers selected by the player with the numbers of the twenty elements drawn in the process of step S17. Alternatively, in a case where a “Catch All” game has been selected, the winning determination processing is executed with reference to the winning table shown in FIG. 28 by comparing the two to seven numbers selected by the player with the numbers of the twenty elements drawn in the process in step S17. In a case where a “Top or Bottom” game has been selected, after determined whether the numbers of the twenty elements drawn in the process in step S17 are tops (numbers from 1 to 40) or bottoms (numbers from 41 to 80), the winning determination processing is executed according to the number of their numbers with reference to the winning table shown in FIG. 29.

In step S19, the CPU 101 determined whether or not a winning has been brought in the current game based on the process in step S18. If the winning has been brought, a payout is awarded according to each of the winning tables in step S20. In this manner, Keno games are executed.

Next, the game selection processing of step S11 in FIG. 6 will be explained with reference to the flow-chart shown in FIG. 7.

In step S31, the CPU 101 displays icons p1 to p4 each corresponding to “Bet”, “Catch All”, “High Roller” and “Top or Bottom”. Further, an icon p5 corresponding to “OK” is displayed.

In step S32, the CPU 101 accepts the player's input operation. And then, in step S33, the CPU 101 determines whether or not the input operation has been done. If the input operation has been done, a type of games is determined in step S34. For example, when the player touches the “Bet” icon q1, this operation is detected by the touchscreen 108. Subsequently, when the “OK” icon q5 is touched, this operation is detected by the touchscreen 108 to confirm that a “Bet” game has been selected.

In step S35, the CPU 101 stores the game determined in the process in step S34 into the RAM 106. In this manner, the game selection processing by the player is executed.

Next, the setting processing of the number of consecutive games of step S12 in FIG. 6 will be explained with reference to the flow-chart shown in FIG. 8.

In step S51, the CPU 101 determines whether or not a counter N indicating the number of consecutive games is N=0. Note that the counter N is set to zero as default.

If N=0, the CPU 101 set an elimination judgment flag Fa to “Fa=0” in step S52. As explained later, the elimination judgment flag Fa is set to “1” when a condition to eliminate elements has been met. The elimination judgment flag Fa is set to zero as default.

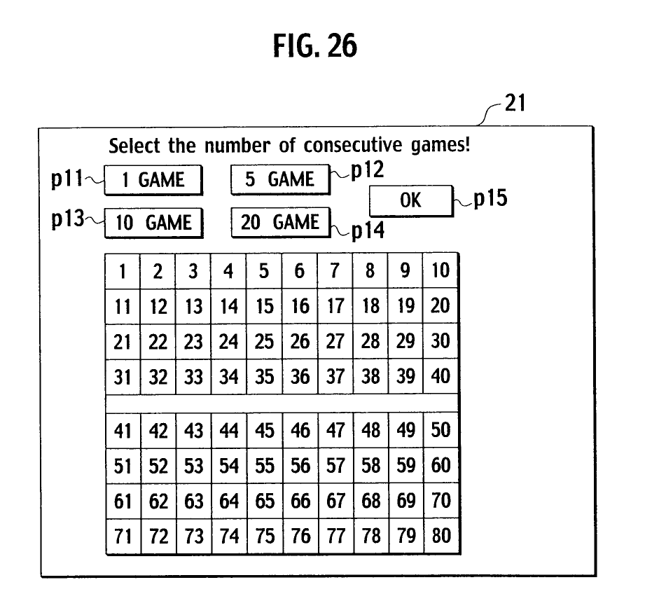

In step S53, the CPU 101 displays icons for selecting the number of consecutive games on the display 21. For example, a “1 game” icon p11, a “5games” icon p12, a “10 games” icon p13 and a “20 games” icon p14 are displayed as shown in FIG. 26. Further, an “OK” icon p15 is also displayed.

In step S54, the CPU 101 accepts the player's input operation. If the input operation has been done, the number of consecutive games is determined in step S55. For example, when the player touches the “10 games” icon p13, this operation is detected by the touchscreen 108. Subsequently, when the “OK” icon p15 is touched, this operation is detected by the touchscreen 108.

As a result, the CPU 101 set the number of consecutive games to 10 games in step S55.

In step S56, the CPU 101 set the determined number of games into N (in this case, N=10).

In step S57, the CPU 101 accepts a player's number selection process according to the game selected in the processing of step 11 in FIG. 6. For example, in a case where a “Bet” game has been selected, accepted is a selection process in which one to fifteen of numbers are selected from numbers 1 to 80. In this case, text strings ‘“Bet” game starts! Select up to fifteen numbers from eighty numbers!’ and the numbers 1 to 80 are displayed on the display 21 as shown in FIG. 19. And then, when the player has touched the numbers to select, the selected numbers are confirmed by the touchscreen 108 (see FIG. 2).

Alternatively, in a case where a “High Roller” game has been selected, accepted is a selection process in which one to fifteen of numbers are selected from numbers 1 to 80. In this case, text strings ‘“High Roller” game starts! Select up to fifteen numbers from eighty numbers!’ and the numbers 1 to 80 are displayed on the display 21 as shown in FIG. 23. And then, when the player has touched the numbers to select, the selected numbers are confirmed by the touchscreen 108.

In a case where a “Catch All” game has been selected, accepted is a selection process in which two to seven of numbers are selected from numbers 1 to 80. In this case, text strings ‘“Catch All” game starts! Select two to seven numbers from eighty numbers!’ and the numbers 1 to 80 are displayed on the display 21 as shown in FIG. 25. And then, when the player has touched the numbers to select, the selected numbers are confirmed by the touchscreen 108.

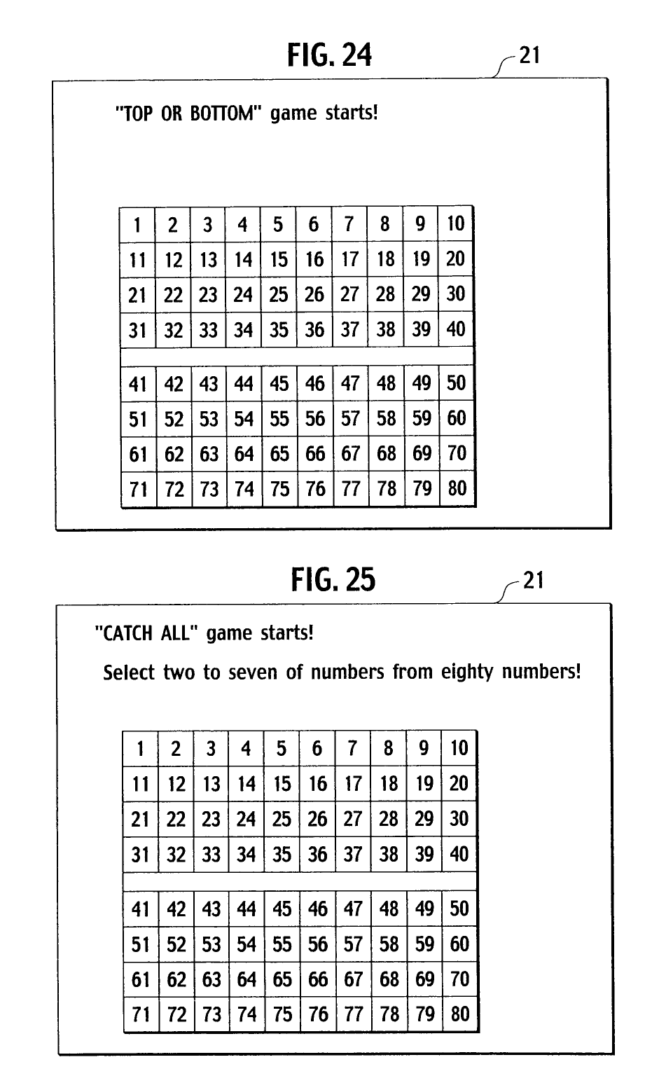

In a case where a “Top or Bottom” game has been selected, accepted is a selection process in which two to seven of numbers are selected from numbers 1 to 80. In this case, a text string ‘“Top or Bottom” game starts!’ is displayed on the display 21 as shown in FIG. 24. And then, process flow proceeds to step S58 in FIG. 8 without number selections.

In step S58 in FIG. 8, the CPU 101 determines whether or not the number N of games is “N>5”. Therefore, this determination will be NO if the number of consecutive games is one or five games and YES if the number of consecutive games is ten or twenty games.

If it is determined “N>5” in step S58, the CPU 101 set the elimination judgment flag Fa to “Fa=1” in step S59. The elimination judgment flag Fa is used in the after-mentioned element elimination processing.

And then, when the number N of consecutive games has been determined according to the above-mentioned processes, N-times Keno games with the identical types of games and the identical set of the selected numbers are executed automatically without executing the game selection processing of step S11 in FIG. 6.

In addition, if not N=0 in the process of step S51, it is assumed that consecutive games had been set in the previous game have not finished yet. In this case, N=N−1 is set (step S60) and then this processing is terminated. In this manner, the setting processing of the number of consecutive games is executed.

Next, the element elimination processing of step S13 in FIG. 6 will be explained with reference to the flow-chart shown in FIG. 9.

In step S71, the CPU 101 determines whether or not the elimination judgment flag is Fa=1. Namely, if the elimination judgment flag has been set Fa=1 in the process of step S59 in FIG. 8, it is determined YES in step S71. If the elimination judgment flag has not been set Fa=1, it is determined NO in step S71.

In step S72, the CPU 101 determines whether or not it would be done to eliminate a predetermined number of numbers from eighty numbers. This determination process is made at random with a predetermined probability.

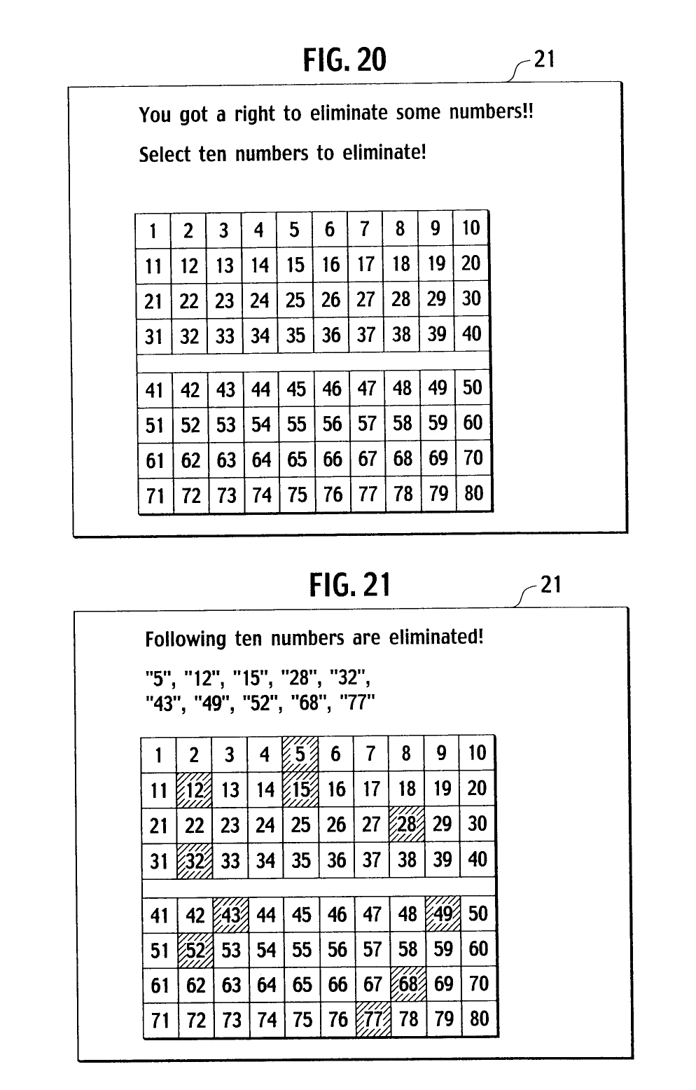

If it has been determined to eliminate numbers in a process of step S73, an M number of numbers to be eliminated is determined at random in a process of step S74. As a result, if M=10 has been determined, text strings “you got a right to eliminate some numbers! Select ten numbers to eliminate!” are displayed on the display 21 as shown in FIG. 20 to inform the player of an acquisition of right to eliminate ten numbers from eighty numbers.

In step S75, the CPU 101 accepts inputs of numbers to be eliminated. In this process, numbers 1 to 80 are displayed on the display 21 as shown in FIG. 20 and selected numbers are confirmed by detecting the numbers touched by the player by the touchscreen 108.

In step S76, the CPU 101 determines whether or not the M number of numbers (ten numbers in this case) have been selected.

If the M number of numbers have been selected, the CPU 101 displays the selected M number of numbers (ten numbers in this case) invertedly in step S77 to inform the player of the eliminated numbers. For example, if ten numbers “5”, “12”, “15”, “28”, “32”, “43”, “49”, “52”, “68” and “72” has been selected as objects to be eliminated, these numbers are displayed invertedly (see FIG. 21).

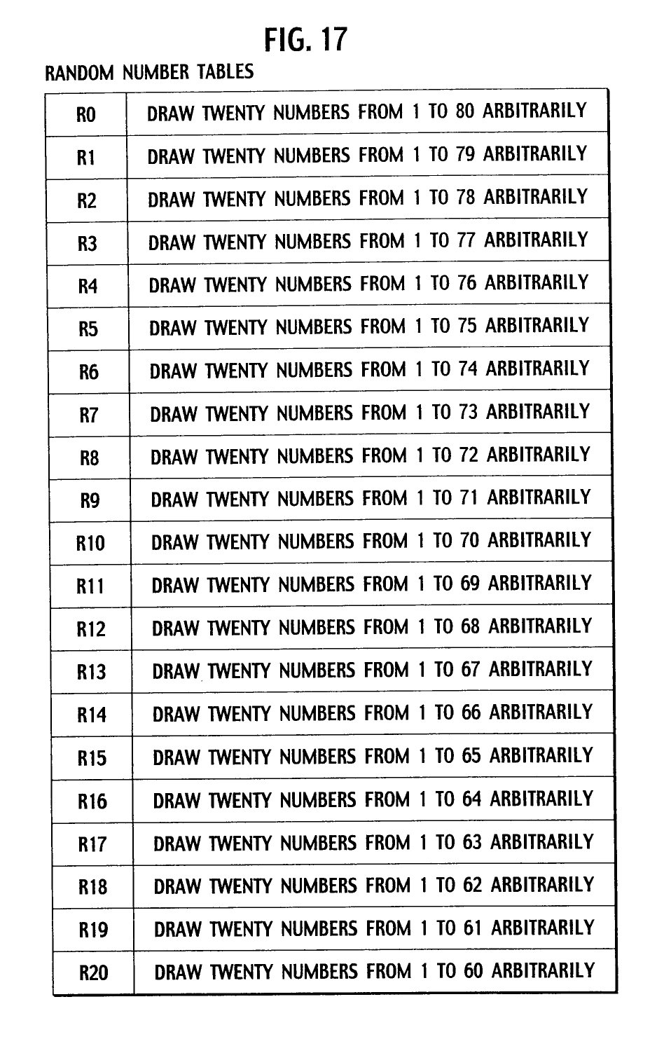

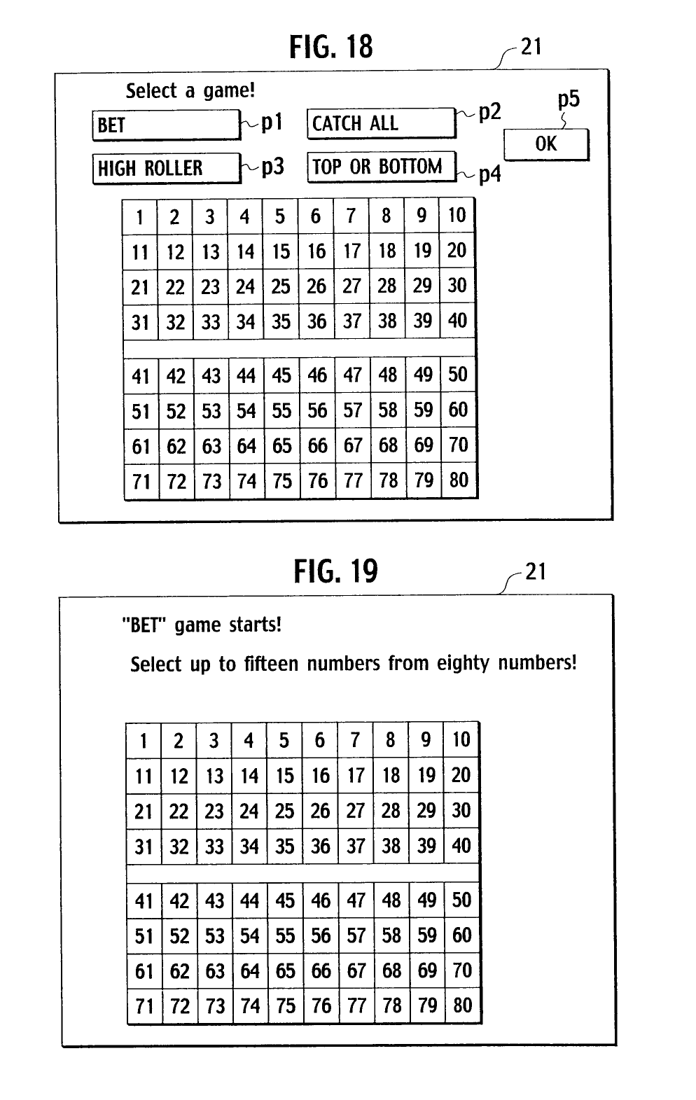

In step S78, the CPU 101 selects a random number table based on the M number of eliminated numbers. As shown in FIG. 17, total twenty-one random number tables R0 to R20 are stored in the RAM 106. If no number has been eliminated (in case of M=0), the random number table R0 is selected. If the number M of eliminated numbers is M=1, the random number table R1 is selected. Similarly, if the number M of eliminated numbers is M=20, the random number table R20 is selected.

For example, random numbers for drawing arbitrary twenty numbers from seventy-nine numbers are defined in the random number table R1. In addition, random numbers for drawing arbitrary twenty numbers from sixty numbers are defined in the random number table R20. Therefore, probability of matching between the numbers selected by the player and the numbers of the drawn elements increases in an order R0, R1, R2, . . . R20. And, the random number table selected in the process of step 78 in FIG. 9 is used in the process of step S17 in FIG. 6. In this manner, the element elimination processing is executed.

In addition, in the number selection process of step S57 in FIG. 8, the eliminated numbers are excluded from objects to be selected by being displayed inversely.

As explained above, in the gaming machine of the first embodiment according to the present invention, when a player has selected consecutive games beyond the predetermined number of plays (e.g. five games), it is determined during the consecutive games whether or not to allow an elimination of numbers. If it is determined to eliminate some numbers, the predetermined number of elements (e.g. ten elements) are eliminated from eighty elements each numbered with a number 1 to 80. And then, twenty elements are drawn from the elements without the eliminated elements (e.g. seventy element) to proceed each type of games (“Bet”, “Catch All”, “High Roller” and “top or Bottom”).

Therefore, the more the number of eliminated elements increases, the more likely to be drawn the elements having the numbers selected by a player. And thereby a probability for awarding a winning to the player is made higher. Therefore, the player can be motivated to play consecutive games and thereby an entertainment feature can be improved.

Next, a gaming machine in a second embodiment according to the present invention will be explained. Since configurations of the gaming machine are similar to those of the gaming machine in the above-described first embodiment, redundant explanations of them are omitted.

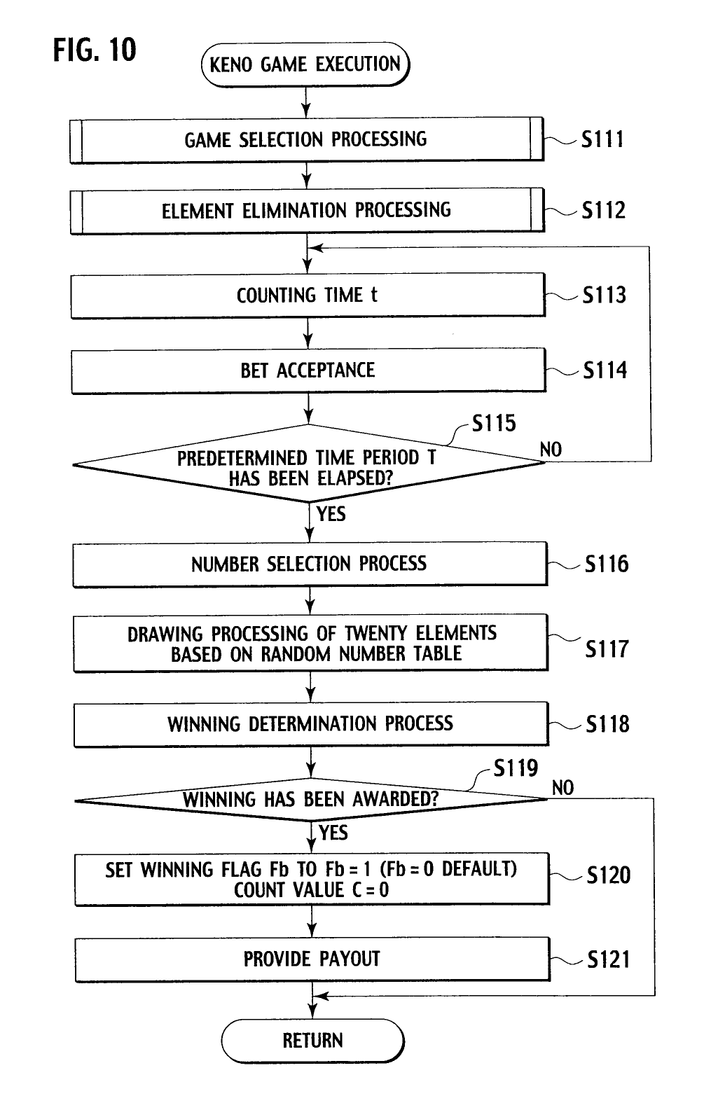

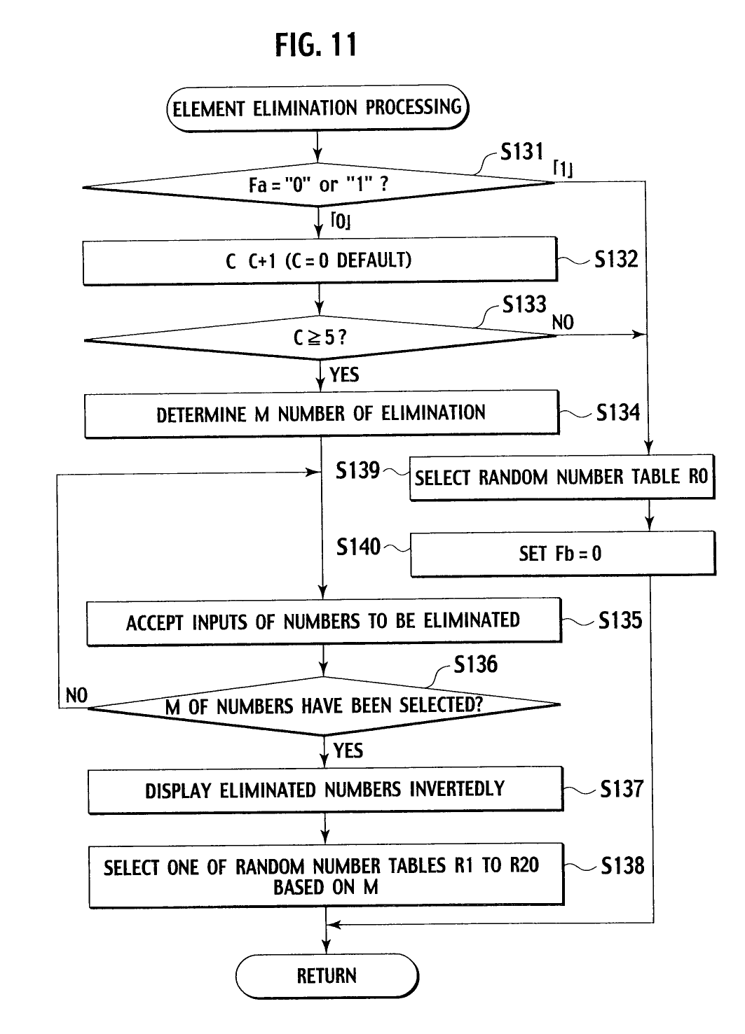

Hereinafter, operational processes of the gaming machine according to the second embodiment will be explained with reference to flow-charts shown in FIGS. 10 and 11. FIG. 10 is the flow-chart showing an execution processing of a Keno game executed at the gaming machine according to the second embodiment.

In step S111, the CPU 101 (see FIG. 2) executes a game selection processing. Since the game selection processing is the same as the above-explained processing shown in FIG. 7, its redundant explanation is omitted.

In step S112, the CPU 101 executes an element elimination processing. In this processing, the number of total elements is decreased by eliminating a predetermined number of elements from eighty elements in a case where an after-mentioned condition has been met. Its detail will be explained later with reference to the flow-chart shown in FIG. 11.

In step S113, the CPU 101 puts a timer implemented in the RAM 106 into operation to count an elapsed time t from a Keno game start.

In step S114, the CPU 101 accepts a bet. In this process, a credit amount is accumulated according to an inserted amount of coins or bills after accepting a coin insertion into the medal insertion slot 29 and a bill insertion into the bill insertion slot 30 by a player to display the credit amount on the credit amount indicator 25. Further, operations onto the bet button 23, the max-bet button 24 and the repeat-bet button 22 are accepted and a bet of credits according to the operations onto the buttons is placed. The bet credits is displayed on the bet amount indicator 26 and the credit amount had been decreased by the bet credit is displayed on the credit amount indicator 25.

In step S115, the CPU 101 determines whether or not the counted time t by the timer has reached a predetermined time T. If it has reached to the predetermined time T, the bet acceptance is terminated.

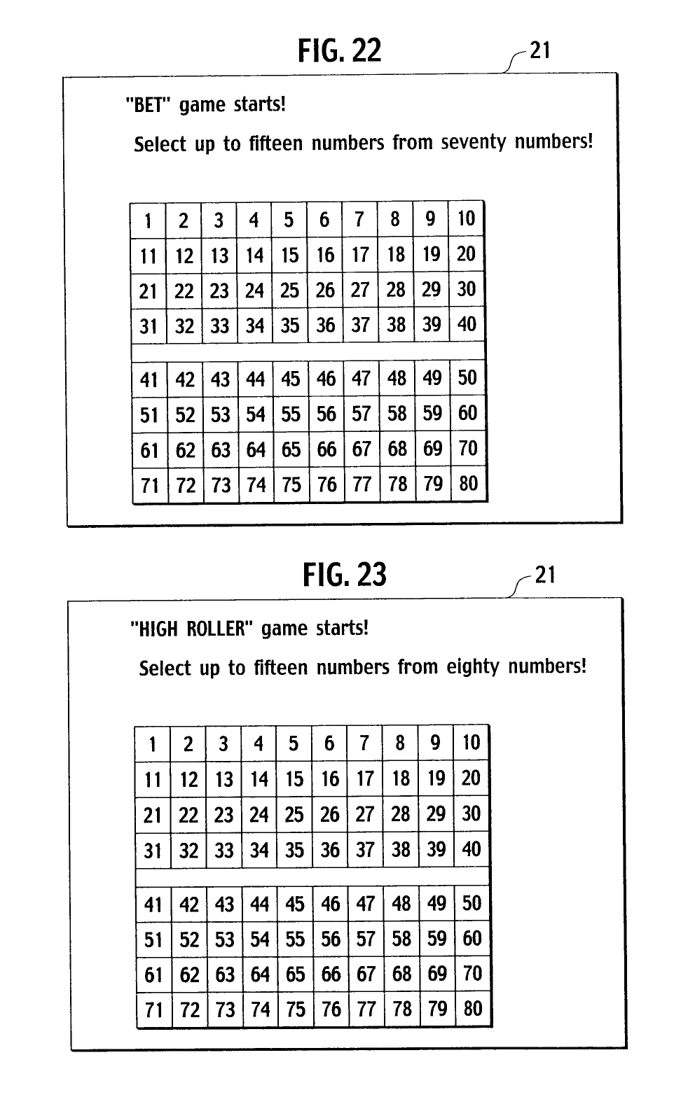

In step S116, the CPU 101 accepts a player's number selection process according to the game selected in the processing of step 111. For example, in a case where a “Bet” game has been selected, accepted is a selection process in which one to fifteen of numbers are selected from numbers 1 to 80. In this case, text strings ‘“Bet” game starts! Select up to fifteen numbers from eighty numbers!’ and the numbers 1 to 80 are displayed on the display 21 as shown in FIG. 19. And then, when the player has touched the numbers to select, the selected numbers are confirmed by the touchscreen 108 (see FIG. 2). Alternatively, in a case where, for example, ten elements have been eliminated in the element elimination processing of step S112, text strings ‘“Bet” game starts! Select up to fifteen numbers from seventy numbers!’ and the numbers 1 to 80 are displayed on the display 21 as shown in FIG. 22. In this case, the eliminated ten numbers cannot be selected as shown in FIG. 21.

Alternatively, in a case where a “High Roller” game has been selected, accepted is a selection process in which one to fifteen of numbers are selected from numbers 1 to 80. In this case, text strings ‘“High Roller” game starts! Select up to fifteen numbers from eighty numbers!’ and the numbers 1 to 80 are displayed on the display 21 as shown in FIG. 23. And then, when the player has touched the numbers to select, the selected numbers are confirmed by the touchscreen 108.

In a case where a “Catch All” game has been selected, accepted is a selection process in which two to seven of numbers are selected from numbers 1 to 80. In this case, text strings ‘“Catch All” game starts! Select two to seven numbers from eighty numbers!’ and the numbers 1 to 80 are displayed on the display 21 as shown in FIG. 25. And then, when the player has touched the numbers to select, the selected numbers are confirmed by the touchscreen 108.

In a case where a “Top or Bottom” game has been selected, accepted is a selection process in which two to seven of numbers are selected from numbers 1 to 80. In this case, a text string ‘“Top or Bottom” game starts!’ is displayed on the display 21 as shown in FIG. 24. And then, process flow proceeds to step S117 in FIG. 10 without number selections.

Here, in a case where the element elimination processing (to be explained later in detail) shown in step S112 has been eliminated, the eliminated numbers are excluded from selection objects. For example, in a case where ten numbers have been eliminated in the process of step S112, these ten numbers are made out of selection objects and the predetermined number of numbers are selected from total seventy numbers.

In step S117, the CPU 101 repeats a process twenty times in which one element is drawn at random from the eighty elements (the elements after the elimination in a case where some elements has been eliminated; e.g. seventy elements) to draw twenty elements in total.

Instep S118, the CPU 101 executes a winning determination processing. In this processing, a winning determination is made according to each type of games. For example, in a case where a “Bet” game has been selected, the winning determination processing is executed with reference to the winning table shown in FIG. 27 by comparing the one to fifteen numbers selected by the player with the numbers of the twenty elements drawn in the process of step S117. Alternatively, in a case where a “Catch All” game has been selected, the winning determination processing is executed with reference to the winning table shown in FIG. 28 by comparing the two to seven numbers selected by the player with the numbers of the twenty elements drawn in the process in step S117. In a case where a “Top or Bottom” game has been selected, after determined whether the numbers of the twenty elements drawn in the process in step S117 are tops (numbers from 1 to 40) or bottoms (numbers from 41 to 80), the winning determination processing is executed according to the number of their numbers with reference to the winning table shown in FIG. 29.

In step S119, the CPU 101 determined whether or not a winning has been brought based on the process in step S118. If the winning has been brought, the CPU 101 set a winning flag Fb to “Fb=1” in step S120. The winning flag Fb is a flag that is set to “1” when a winning is brought in a Keno game and is set to “0” as default. In addition, an after-mentioned count value C is set to “C=0”. The count value C is a value counted by a counter implemented in the RAM 106.

In step S121, the CPU 101 provides a payout based on a winning table. In this manner, a Keno game is executed.

Next, the element elimination processing of step S112 in FIG. 10 will be explained with reference to the flow-chart shown in FIG. 11.

In step S131, the CPU 101 determines whether the winning flag Fb is “0” or “1”. As explained in step S120 in FIG. 10, the winning flag Fb is set to “1” if a game resulted in a wining and it set to “0” if a game didn't result in a winning. If “Fb=1”, a process flow proceeds to step S139.

If Fb=“0”, the CPU 101 increments the count value C of the counter set in the RAM 106 in step S132. Specifically, a process of “C=C+1” is executed. The count value C indicates the number of successive games without a winning and is set to C=0 as default. Note that the count value C will be reset in a case where a Keno game has resulted in a winning as shown in step S120 in FIG. 10. In other words, the count value C indicates the number of successive Keno games without a winning.

In step S133, the CPU 101 determines whether or not the count value C is equal-to or more-than “5”. If the count value C is equal-to or more-than “5”, the process flow proceeds to step 134. If the count value C is smaller than “5”, the process flow proceeds to step 139.

In step S134, the CPU 101 determines an M number of elements to be eliminated at random. Here, the maximum value of the M number of elements to be eliminated is set to twenty. Therefore, in the process of step S134, a value of the M number is set to one of the numbers 0 to 20. Note that, M=0 represents that no element is to be eliminated.

As a result, if M=10 has been determined, text strings “you got a right to eliminate some numbers! Select ten numbers to eliminate!” are displayed on the display 21 as shown in FIG. 20 to inform the player of an acquisition of right to eliminate ten numbers from eighty numbers.

In step S135, the CPU 101 accepts inputs of numbers to be eliminated. In this process, numbers 1 to 80 are displayed on the display 21 as shown in FIG. 20 and selected numbers are confirmed by detecting the numbers touched by the player by the touchscreen 108.

In step S136, the CPU 101 determines whether or not the M number of numbers (ten numbers in this case) have been selected.

If the M number of numbers have been selected, the CPU 101 displays the selected M number of numbers (ten numbers in this case) inversely in step S137 to inform the player of the eliminated numbers. For example, if ten numbers “5”, “12”, “15”, “28”, “32”, “43”, “49”, “52”, “68” and “72” has been selected as objects to be eliminated, these numbers are displayed inversely (see FIG. 21).

In step S138, the CPU 101 selects a random number table based on the M number of eliminated numbers. As shown in FIG. 17, total twenty-one random number tables R0 to R20 are stored in the RAM 106. If no number has been eliminated (in case of M=0), the random number table R0 is selected. If the number M of eliminated numbers is M=1, the random number table R1 is selected. Similarly, if the number M of eliminated numbers is M=20, the random number table R20 is selected.

For example, random numbers for drawing arbitrary twenty numbers from seventy-nine numbers are defined in the random number table R1. In addition, random numbers for drawing arbitrary twenty numbers from sixty numbers are defined in the random number table R20. Therefore, probability of matching between the numbers selected by the player and the numbers of the drawn elements increases in an order R0, R1 ,R2, . . . R20. And, the random number table selected in the process of step 138 in FIG. 11 is used in the process of step S117 in FIG. 10. In this manner, the element elimination processing is executed.

As explained above, in the gaming machine of the second embodiment according to the present invention, when games without a winning have continued for equal-to or more-than the predetermined number of games (e.g. five games), the determination for eliminating some elements is made in the next game. If it has been determined to eliminate some elements, the predetermined number of elements (e.g. ten elements) are eliminated from eighty elements each numbered with a number 1 to 80. And then, twenty elements are drawn from the elements without the eliminated elements (e.g. seventy element) to proceed each type of games (“Bet”, “Catch All”, “High Roller” and “top or Bottom”).

Therefore, the more the number of eliminated elements increases, the more likely to be drawn the numbers selected by a player. And thereby a probability for awarding a winning to the player is made higher. Therefore, a player who has not been awarded in succession can be motivated to play games continuously.

Next, a gaming machine in a third embodiment according to the present invention will be explained. Since configurations of the gaming machine are similar to those of the gaming machine in the above-described first embodiment, redundant explanations of them are omitted.

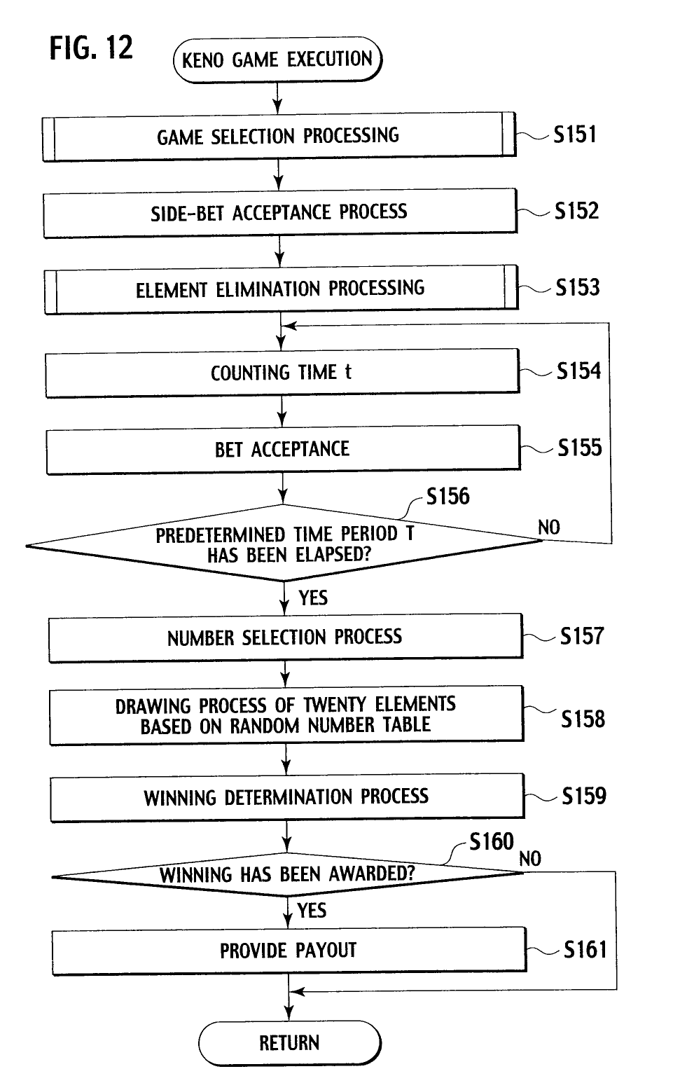

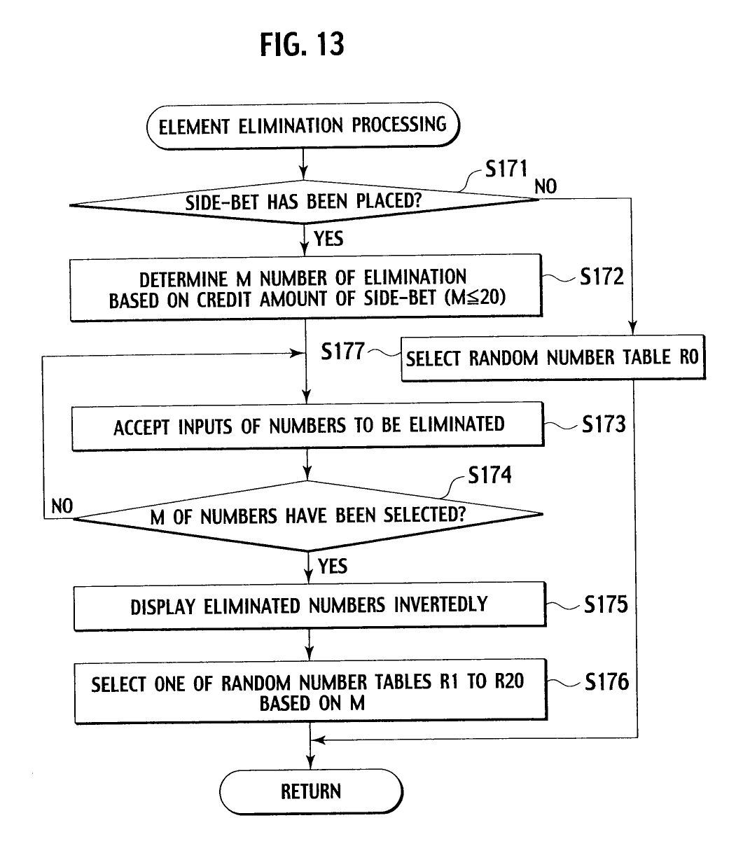

Hereinafter, operational processes of the gaming machine according to the third embodiment will be explained with reference to flow-charts shown in FIGS. 12 and 13. FIG. 12 is the flow-chart showing an execution processing of a Keno game executed at the gaming machine according to the third embodiment.

In step S151, the CPU 101 (see FIG. 2) executes a game selection processing. Since the game selection processing is the same as the above-explained processing shown in FIG. 7, its redundant explanation is omitted.

In step S152, the CPU 101 executes a side-bet acceptance process. In this process, operations onto the side-bet button 31 shown in FIGS. 1 and 2 are detected to determine whether or not a side-bet is placed.

In step S153, the CPU 101 executes an element elimination processing. In this processing, the number of total elements is decreased by eliminating a predetermined number of elements from eighty elements in a case where an after-mentioned condition has been met. Its detail will be explained later with reference to the flow-chart shown in FIG. 13.

In step S154, the CPU 101 puts a timer implemented in the RAM 106 into operation to count an elapsed time t from a Keno game start.

In step S155, the CPU 101 accepts a bet. In this process, a credit amount is accumulated according to an inserted amount of coins or bills after accepting a coin insertion into the medal insertion slot 29 and a bill insertion into the bill insertion slot 30 by a player to display the credit amount on the credit amount indicator 25. Further, operations onto the bet button 23, the max-bet button 24 and the repeat-bet button 22 are accepted and a bet of credits according to the operations onto the buttons is placed. The bet credits is displayed on the bet amount indicator 26 and the credit amount had been decreased by the bet credit is displayed on the credit amount indicator 25.

In step S156, the CPU 101 determines whether or not the counted time t by the timer has reached a predetermined time T. If it has reached to the predetermined time T, the bet acceptance is terminated.

In step S157, the CPU 101 accepts a player's number selection process according to the game selected in the processing of step 151. For example, in a case where a “Bet” game has been selected, accepted is a selection process in which one to fifteen of numbers are selected from numbers 1 to 80. In this case, text strings ‘“Bet” game starts! Select up to fifteen numbers from eighty numbers!’ and the numbers 1 to 80 are displayed on the display 21 as shown in FIG. 19. And then, when the player has touched the numbers to select, the selected numbers are confirmed by the touchscreen 108 (see FIG. 2).

Alternatively, in a case where a “High Roller” game has been selected, accepted is a selection process in which one to fifteen of numbers are selected from numbers 1 to 80. In this case, text strings ‘“High Roller” game starts! Select up to fifteen numbers from eighty numbers!’ and the numbers 1 to 80 are displayed on the display 21 as shown in FIG. 23. And then, when the player has touched the numbers to select, the selected numbers are confirmed by the touchscreen 108.

In a case where a “Catch All” game has been selected, accepted is a selection process in which two to seven of numbers are selected from numbers 1 to 80. In this case, text strings ‘“Catch All” game starts! Select two to seven numbers from eighty numbers!’ and the numbers 1 to 80 are displayed on the display 21 as shown in FIG. 25. And then, when the player has touched the numbers to select, the selected numbers are confirmed by the touchscreen 108.

In a case where a “Top or Bottom” game has been selected, accepted is a selection process in which two to seven of numbers are selected from numbers 1 to 80. In this case, a text string ‘“Top or Bottom” game starts!’ is displayed on the display 21 as shown in FIG. 24. And then, process flow proceeds to step S158 in FIG. 12 without number selections.

Here, in a case where the element elimination processing (to be explained later in detail) shown in step S153 has been eliminated, the eliminated numbers are excluded from selection objects. For example, in a case where ten numbers have been eliminated in the process of step S153, these ten numbers are made out of selection objects and the predetermined number of numbers are selected from total seventy numbers.

In step S158, the CPU 101 repeats a process twenty times in which one element is drawn at random from the eighty elements (the elements after the elimination in a case where some elements has been eliminated; e.g. seventy elements) to draw twenty elements in total.

In step S159, the CPU 101 executes a winning determination processing. In this processing, a winning determination is made according to each type of games. For example, in a case where a “Bet” game has been selected, the winning determination processing is executed with reference to the winning table shown in FIG. 27 by comparing the one to fifteen numbers selected by the player with the numbers of the twenty elements drawn in the process of step S158. Alternatively, in a case where a “Catch All” game has been selected, the winning determination processing is executed with reference to the winning table shown in FIG. 28 by comparing the two to seven numbers selected by the player with the numbers of the twenty elements drawn in the process in step S158. In a case where a “Top or Bottom” game has been selected, after determined whether the numbers of the twenty elements drawn in the process in step S158 are tops (numbers from 1 to 40) or bottoms (numbers from 41 to 80), the winning determination processing is executed according to the number of their numbers with reference to the winning table shown in FIG. 29.

In step S160, the CPU 101 determined whether or not a winning has been brought in the current game based on the process in step S159. If the winning has been brought, the CPU 101 provides a payout based on a winning table in step S161. In this manner, a Keno game is executed.

Next, the element elimination processing of step S153 in FIG. 12 will be explained with reference to the flow-chart shown in FIG. 13.

In step S171, the CPU 101 determines whether or not a side-bet has been placed. in this process, it is judged that a side-bet has been placed in a case where a side-bet operation was detected in the process of step S152 in FIG. 12.

If a side-bet has been placed, the CPU 101 determines an M number of elements to be eliminated according to a credit amount for the side-bet. For example, M=2 in a case where a credit amount for the side-bet is “5”, M=5 in a case where a credit amount for the side-bet is “10” and so on. However, the maximum value of “M” is “20”.

In step S173, the CPU 101 accepts inputs of numbers to be eliminated. In this process, numbers 1 to 80 are displayed on the display 21 as shown in FIG. 20 and selected numbers are confirmed by detecting the numbers touched by the player by the touchscreen 108.

In step S174, the CPU 101 determines whether or not the M number of numbers (ten numbers in this case) have been selected.

If the M number of numbers have been selected, the CPU 101 displays the selected M number of numbers (ten numbers in this case) inversely in step S137 to inform the player of the eliminated numbers. For example, if ten numbers “5”, “12”, “15”, “28”, “32”, “43”, “49”, “52”, “68” and “72” has been selected as objects to be eliminated, these numbers are displayed inversely (see FIG. 21).

In step S176, the CPU 101 selects a random number table based on the M number of eliminated numbers. As shown in FIG. 17, total twenty-one random number tables R0 to R20 are stored in the RAM 106. If no number has been eliminated (in case of M=0), the random number table R0 is selected. If the number M of eliminated numbers is M=1, the random number table R1 is selected. Similarly, if the number M of eliminated numbers is M=20, the random number table R20 is selected.

For example, random numbers for drawing arbitrary twenty numbers from seventy-nine numbers are defined in the random number table R1. In addition, random numbers for drawing arbitrary twenty numbers from sixty numbers are defined in the random number table R20. Therefore, probability of matching between the numbers selected by the player and the numbers of the drawn elements increases in an order R0, R1, R2, . . . R20. And, the random number table selected in the process of step 176 in FIG. 13 is used in the process of step S158 in FIG. 12. In this manner, the element elimination processing is executed.

In addition, if a side-bet has not been placed in step S171, the CPU 101 selects the random number table R0 in step S177. In this manner, the element elimination processing is executed.

As explained above, in the gaming machine of the third embodiment according to the present invention, the number of elements to be eliminated is determined according to a credit amount of a side-bet. In addition, the more the credit amount is, the more large number is set as the number of elements to be eliminated. If some elements are to be eliminated, the predetermined number of elements (e.g. ten elements) are eliminated from eighty elements each numbered with a number 1 to 80. And then, twenty elements are drawn from the elements without the eliminated elements (e.g. seventy element) to proceed each type of games (“Bet”, “Catch All”, “High Roller” and “top or Bottom”).

Therefore, the more the number of eliminated elements increases, the more likely to be drawn the numbers selected by a player. And thereby a probability for awarding a winning to the player is made higher. Therefore, the player can be motivated to place a side-bet.

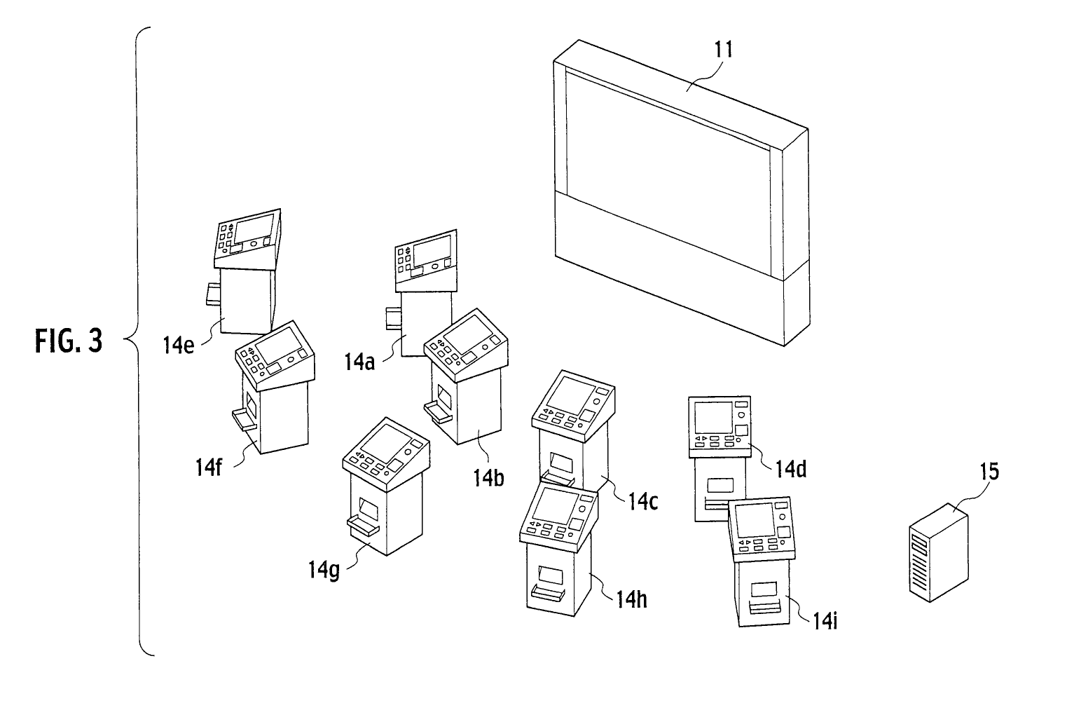

Next, a gaming system in a fourth embodiment according to the present invention will be explained. The gaming system includes plural gaming machines and thereby plural players can play. FIG. 3 is an appearance view of the gaming system according to the fourth embodiment, which includes a communal display 11, the plural (nine in the drawing) gaming machines provided in a fan-like arrangement around the communal display 11 and a host server 15 for executing a Keno game on the communal display 11.

FIG. 4 is a block diagram showing an electronic configuration of the gaming machine used in the gaming system according to the fourth embodiment. The gaming machine 14 shown therein is different from the gaming machine 13 shown in FIG. 2 in that it includes a communication I/F 104. In other words, the gaming machine 14 shown in FIG. 4 is connected with the host server 15 via a network and has a function to transmit a variety of data. Note that, since the appearance of the gaming machine 14 is identical to that shown in FIG. 1, its redundant explanation is omitted.

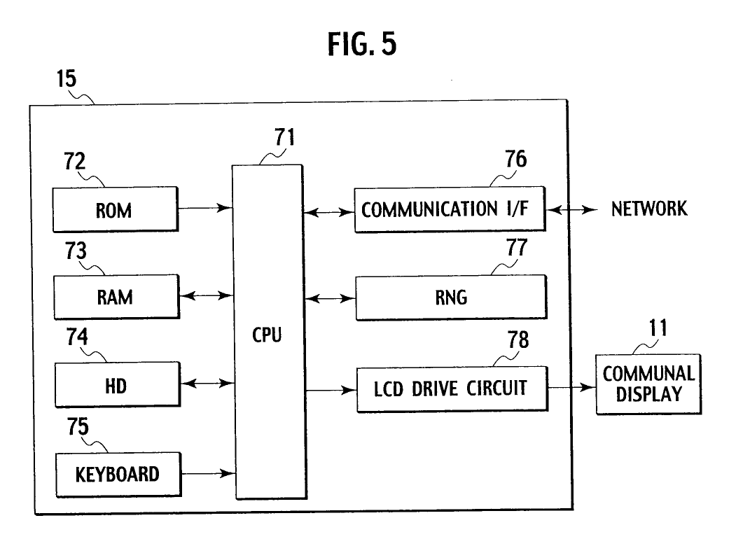

FIG. 5 is a block diagram showing an electronic configuration of the host server 15. As shown in FIG. 5, the host server 15 includes a CPU 71 for executing an overall control of a Keno game execution, a ROM 72, a RAM 73, a hard disk 74 for storing the random number tables, various payout tables or the like, a keyboard 75 for accepting administrator's operation inputs, a communication I/F 76 for communication with the gaming machines 14 (14a to 14i) via the network (not shown), an RNG for generating a variety of random numbers relating to the Keno game execution and an LCD drive circuit 78 for controlling image screens displayed on the communal display 11. The LCD drive circuit 78 is connected with the communal display 11.

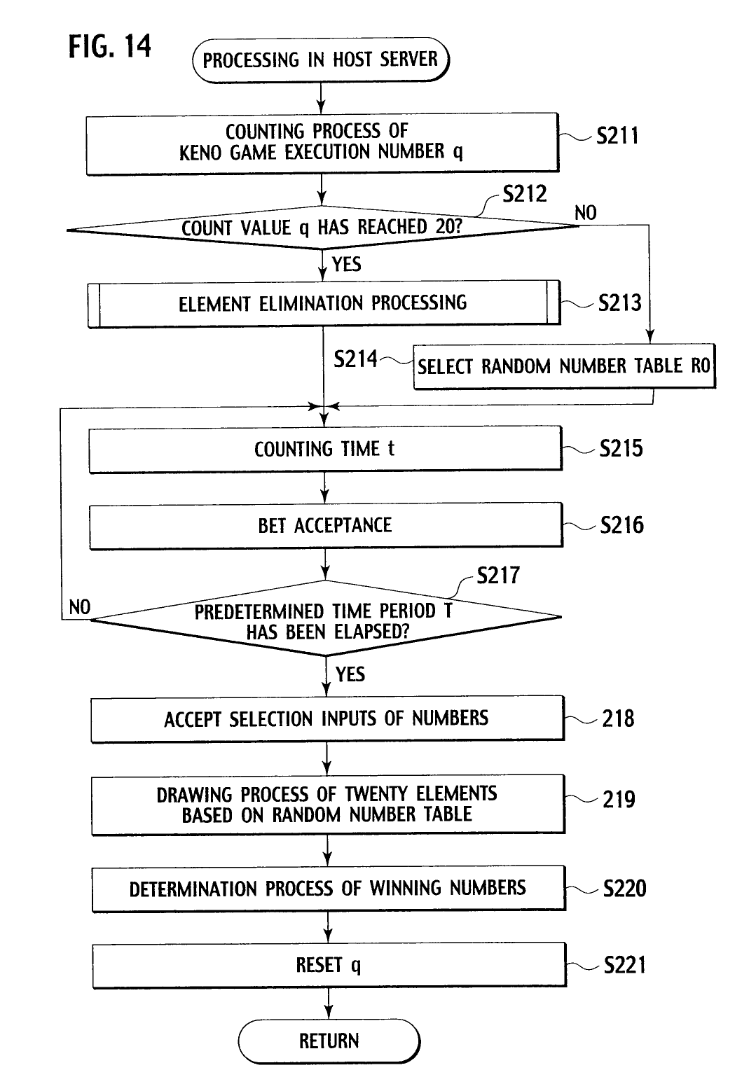

Next, operational processes of the gaming machine according to the fourth embodiment as configured above will be explained with reference to flow-charts shown in FIGS. 14 to 16. FIG. 14 is the flow-chart showing processes by the host server 15.

In step S211, the CPU 71 executes a counting process of a Keno game execution number q. The execution number q is incremented each execution of a Keno game.

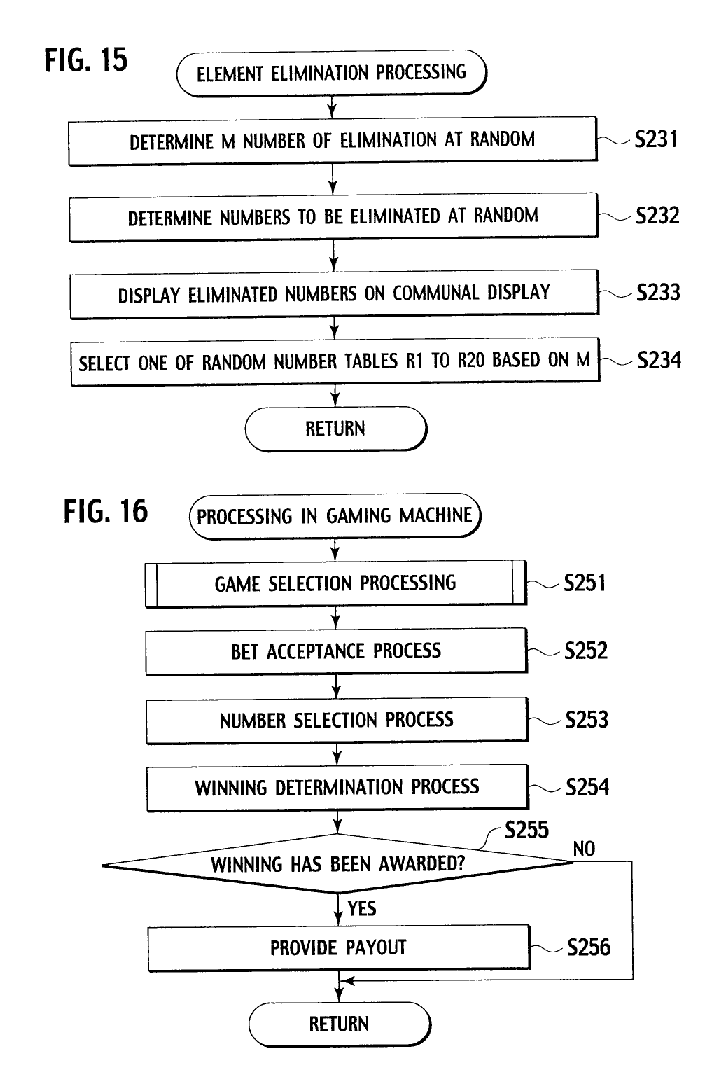

In step S212, the CPU 71 determines whether or not the execution number q=20. If q=20, the CPU 71 executes an element elimination processing in step S213. In this processing, the number of total elements is decreased by eliminating a predetermined number of elements from eighty elements. Its detail will be explained later with reference to the flow-chart shown in FIG. 15.

Alternatively, if not q=20 in step S212, the CPU 71 selects the random number table R0 shown in FIG. 17 in step S214.

In step S215, the CPU 71 puts a timer implemented in the RAM 73 into operation to count an elapsed time t from a Keno game start.

In step S216, the CPU 71 accepts bets. In this process, a command signal for starting a bet acceptance is output to each of the gaming machines 14 (14a to 14i). Herewith, at each of the gaming machines 14 (14a to 14i), accepted will be a coin insertion into the medal insertion slot 29 and a bill insertion into the bill insertion slot 30 by a player and further accepted will be operations onto the bet button 23, the max-bet button 24 and the repeat-bet button 22.

In step S217, the CPU 71 determines whether or not the counted time t by the timer has reached a predetermined time T. If it has reached to the predetermined time T, the bet acceptance is terminated.

In step S218, the CPU 71 outputs a command signal for starting acceptance of number selection inputs to each of the gaming machines 14 (14a to 14i). Herewith, at each of the gaming machines 14 (14a to 14i), a process for selecting arbitrary numbers from the eighty elements (elements after the elimination in a case where some elements has been eliminated).

In step S219, the CPU 71 repeats a process twenty times in which one element is drawn from the eighty elements (the elements after the elimination in a case where some elements has been eliminated; e.g. seventy elements) using the random number table to draw twenty elements in total. In this process, the random number table associated with the number of eliminated elements is used. Specifically, the element elimination processing is executed with any one of the random number tables R0 to R20 according to the number of eliminated elements as shown in FIG. 17.

In step S220, the CPU 71 executes a determination process of winning numbers. In this process, numbers on the twenty elements drawn in the process of step S219 are determined as the winning numbers. Data of the winning numbers are sent to each of the gaming machines 14 (14a to 14i).

In step S221, the CPU 71 resets the Keno game execution number q. As mentioned above, the host server 15 executes the element elimination processing each twenty Keno game executions and then a Keno game will be executed with the elements after the elimination (e.g. seventy elements).

Next, the element elimination processing of step S213 in FIG. 14 will be explained with reference to the flow-chart shown in FIG. 15.

In step S231, the CPU 71 determines an M number of elements to be eliminated from eighty elements at random. Here, the maximum value of the M number of elements to be eliminated is set to twenty. Therefore, a value of the M number is set to one of the numbers 0 to 20.

In step S232, the CPU 71 determines the numbers to be eliminated at random. For example, in a case where the M number of elements to be eliminated has been determined to “10”, ten numbers are selected at random from the numbers 1 to 80 to exclude the ten numbers out of selectable numbers.

In step S233, the CPU 71 displays the eliminated numbers on the communal display 11. For example, in a case where the eliminated numbers are “5”, “12”, “15”, “28”, “32”, “43”, “49”, “52”, “68” and “72”, these numbers are displayed on the communal display 11. A player at each of the gaming machines 14 (14a to 14i) can recognizes the eliminated numbers by watching this display.

In step S234, the CPU 71 selects a random number table based on the M number of eliminated numbers. As shown in FIG. 17, total twenty-one random number tables R0 to R20 are stored in the RAM 106. If the number M of eliminated numbers is M=1, the random number table R1 is selected. Similarly, if the number M of eliminated numbers is M=20, the random number table R20 is selected.

For example, random numbers for drawing arbitrary twenty numbers from seventy-nine numbers are defined in the random number table R1. In addition, random numbers for drawing arbitrary twenty numbers from sixty numbers are defined in the random number table R20. Therefore, probability of matching between the numbers selected by the player and the numbers of the drawn elements increases in an order R0, R1 ,R2, . . . . R20. And, the random number table selected in the process of step 234 in FIG. 15 is used in the process of step S219 in FIG. 14. In this manner, the element elimination processing is executed.

Next, processes at each of the gaming machines 14 (14a to 14i) will be explained with reference to the flow-chart shown in FIG. 16.

In step S251, the CPU 101 (see FIG. 4) executes a game selection processing. Since the game selection processing is the same as the above-explained processing shown in FIG. 7, its redundant explanation is omitted.

In step S152, the CPU 101 executes abet acceptance process. This process is executed upon receiving the command signal for starting a bet acceptance sent in the process of step S216 shown in FIG. 14. In the bet acceptance process, a credit amount is accumulated according to an inserted amount of coins or bills after accepting a coin insertion into the medal insertion slot 29 and a bill insertion into the bill insertion slot 30 by a player to display the credit amount on the credit amount indicator 25. Further, operations onto the bet button 23, the max-bet button 24 and the repeat-bet button 22 are accepted and a bet of credits according to the operations onto the buttons is placed. The bet credits is displayed on the bet amount indicator 26 and the credit amount had been decreased by the bet credit is displayed on the credit amount indicator 25.

In step S253, the CPU 101 accepts a player's number selection process according to the game selected in the processing of step 251. For example, in a case where a “Bet” game has been selected, accepted is a selection process in which one to fifteen of numbers are selected from numbers 1 to 80. In this case, text strings ‘“Bet” game starts! Select up to fifteen numbers from eighty numbers!’ and the numbers 1 to 80 are displayed on the display 21 as shown in FIG. 19. And then, when the player has touched the numbers to select, the selected numbers are confirmed by the touchscreen 108 (see FIG. 2).

Alternatively, in a case where a “High Roller” game has been selected, accepted is a selection process in which one to fifteen of numbers are selected from numbers 1 to 80. In this case, text strings ‘“High Roller” game starts! Select up to fifteen numbers from eighty numbers!’ and the numbers 1 to 80 are displayed on the display 21 as shown in FIG. 23. And then, when the player has touched the numbers to select, the selected numbers are confirmed by the touchscreen 108.

In a case where a “Catch All” game has been selected, accepted is a selection process in which two to seven of numbers are selected from numbers 1 to 80. In this case, text strings ‘“Catch All” game starts! Select two to seven numbers from eighty numbers!’ and the numbers 1 to 80 are displayed on the display 21 as shown in FIG. 25. And then, when the player has touched the numbers to select, the selected numbers are confirmed by the touchscreen 108.

In a case where a “Top or Bottom” game has been selected, accepted is a selection process in which two to seven of numbers are selected from numbers 1 to 80. In this case, a text string ‘“Top or Bottom” game starts!’ is displayed on the display 21 as shown in FIG. 24. And then, process flow proceeds to step S254 in FIG. 16 without number selections.

Here, in a case where the element elimination processing of step S213 in FIG. 14 has been eliminated, the eliminated numbers are excluded from selection objects. For example, in a case where ten numbers have been eliminated in the process of step S153, these ten numbers are made out of selection objects and the predetermined number of numbers are selected from total seventy numbers.

In step S254, the CPU 101 executes a winning determination processing. In this processing, a winning determination is made according to each type of games. For example, in a case where a “Bet” game has been selected, the winning determination processing is executed with reference to the winning table shown in FIG. 27 by comparing the one to fifteen numbers selected by the player with the numbers of the twenty elements drawn by the host server 15 in the process of step S219 in FIG. 14. Alternatively, in a case where a “Catch All” game has been selected, the winning determination processing is executed with reference to the winning table shown in FIG. 28 by comparing the two to seven numbers selected by the player with the numbers of the twenty elements drawn by the host server 15. In a case where a “Top or Bottom” game has been selected, after determined whether the numbers of the twenty elements drawn by the host server 15 are tops (numbers from 1 to 40) or bottoms (numbers from 41 to 80), the winning determination processing is executed according to the number of their numbers with reference to the winning table shown in FIG. 29.

In step S255, the CPU 101 determined whether or not a winning has been brought. If the winning has been brought, the CPU 101 provides a payout based on a winning table in step S256. In this manner, a Keno game is executed at each of the gaming machine 14 (14a to 14i).

As explained above, at a Keno game execution at each of the gaming machines 14 (14a to 14i), the element elimination processing is executed at each execution of the predetermined number of games. Specifically, the predetermined number of elements (e.g. ten elements) are eliminated from eighty elements each numbered with a number 1 to 80. And then, twenty elements are drawn from the elements without the eliminated elements (e.g. seventy element) to proceed each type of games (“Bet”, “Catch All”, “High Roller” and “top or Bottom”) at each of the gaming machines 14 (14a to 14i).

Therefore, the more the number of eliminated elements increases, the more likely to be drawn the numbers selected by the player. And thereby a probability for awarding a winning to a player at each of the gaming machines 14 (14a to 14i) is made higher. Therefore, the player can be motivated to play games continuously.

Although the gaming machines and the gaming system according to embodiments of the present invention have been described as above, they are only presented as specific examples, without particularly limiting the present invention. Specific arrangements of respective units may be changed in design as appropriate. In addition, the effects set forth in the embodiments of the present invention are merely an enumeration of the most preferred effect which occurs from the present invention, and the effects by the present invention is not limited to those set forth in the embodiments of the present invention.

What is claimed is:

1. A playing method of a gaming machine, comprising:
determining whether or not a predetermined condition relating to a game execution has been met;
executing, upon the predetermined condition being met, an elimination processing for eliminating a predetermined number of numbers from a total number of numbers;
setting the total number of numbers to an overall total number P in a case where the elimination processing has not been executed or setting a resulting number after the elimination processing to an overall total number P in a case where the elimination processing has been executed;
storing n (1≦n<P) number of numbers arbitrarily selected by a player from the overall total number P number of numbers;
drawing m (1≦m<P) number of numbers at random from the overall total number P number of numbers; and
determining an award according to the number of player-selected numbers included in the m number of drawn numbers.

2. The playing method of a gaming machine according to claim 1, wherein
a determination whether or not to execute the elimination processing in each of a plurality of consecutive unit games is made in a case where same numbers are selected through the plurality of consecutive unit games, and
the elimination processing is executed in each unit game for which it has been determined that the elimination processing is to be executed.

3. The playing method of a gaming machine according to claim 1, wherein
the elimination processing is executed upon accepting a sidebet at each unit game and the predetermined number is determined according to a sidebet amount.

4. The playing method of a gaming machine according to claim 1, wherein
the elimination processing is executed in a case where no award has been brought through a plurality of consecutive unit games.

5. A gaming machine, comprising:
a display for displaying images relating to a game thereon; and
a controller being programmed to execute following (a) to (f):
(a) an elimination processing for determining whether or not a predetermined condition relating to a game execution has been met and eliminating, upon the predetermined condition being met, a predetermined number of numbers from a total number of numbers;
(b) a processing for setting the total number of numbers to an overall total number P in a case where the elimination processing has not been executed or setting a resulting number after the elimination processing to an overall total number P in a case where the elimination processing has been executed;
(c) a processing for accepting selections of n (1≦n<P) number of arbitrary numbers from the overall total number P number of numbers;
(d) a processing for drawing m (1≦m<P) number of numbers at random from the overall total number P number of numbers;
(e) a processing for acquiring the number of matching numbers through a comparison between the m number of drawn numbers and the n number of selected numbers; and
(f) a processing for providing an award according to the number of matching numbers.

6. The gaming machine according to claim 5, wherein
the controller further determines whether or not to execute the elimination processing in each of a plurality of consecutive unit games in a case where same numbers are selected through the plurality of consecutive unit games and executes, and executes the elimination processing in each unit game for which it has been determined that the elimination processing is to be executed.

7. The gaming machine according to claim 5, wherein
the controller further executes the elimination processing upon accepting a sidebet at each unit game and determines the predetermined number according to a sidebet amount.

8. The gaming machine according to claim 5, wherein
the controller further executes the elimination processing in a case where no award has been brought through a plurality of consecutive unit games.

9. A gaming system comprising a plurality of gaming machines and a host server connected with each of the plurality of gaming machines via a network, wherein
the host server includes:
a main display; and
a server controller being programmed to execute following (a) to (c):
(a) an elimination processing for determining whether or not a predetermined condition has been met and eliminating, upon the predetermined condition being met, a predetermined number of numbers from a total number of numbers;
(b) a processing for setting the total number of numbers to an overall total number P in a case where the elimination processing has not been executed or setting a resulting number after the elimination processing to an overall total number P in a case where the elimination processing has been executed; and
(c) a processing for drawing m (1≦m<P) number of numbers at random from the overall total number P number of numbers;
each of the plurality of gaming machines includes a terminal controller being programmed to execute following (A) to (C):
(A) a processing for accepting selections of n (1≦n<P) number of arbitrary numbers from the overall total number P number of numbers;
(B) a processing for acquiring the number of matching numbers through a comparison between the m number of drawn numbers and the n number of selected numbers; and
(C) a processing for providing an award according to the number of matching numbers.

10. The gaming system according to claim 9, wherein
the server controller executes the elimination processing each predetermined number of unit game executions.
